(19) United States
(12) Patent Application Publication
(10) Pub. No.: US 2012/0202067 A1
(43) Pub. Date: Aug. 9, 2012

(54) COMPOSITE MICRON DIAMOND PARTICLE AND METHOD OF MAKING

(75) Inventors: Soma Chakraborty, Houston, TX (US); Gaurav Agrawal, Aurora, CO (US)

(73) Assignee: BAKER HUGHES INCORPORATED, Houston, TX (US)

(21) Appl. No.: 13/021,157

(22) Filed: Feb. 4, 2011

(51) Int. Cl. B32B 5/16; B05D 1/36; B82Y 99/00; B82Y 40/00

(52) U.S. Cl. 428/403; 427/203; 977/750; 977/752; 977/773

(57) ABSTRACT

A composite particle is disclosed. The composite particle includes a micron diamond particle. The composite particle also includes a nanoparticle, the nanoparticle attached to a surface of the micron diamond particle by an attachment comprising a covalent bond or an intermolecular force, or a combination thereof. A method of making a composite particle is also disclosed. The method includes providing a micron diamond particle. The method also includes providing a nanoparticle and attaching the nanoparticle to a surface of the micron diamond particle by an attachment comprising a covalent bond or an intermolecular force, or a combination thereof.

### BACKGROUND

Micron diamond particles are used in many applications, including in various coatings, including abrasive and thermally conductive coatings, as fluid additives and in the manufacture of powder compacts. They are used, for example, in the manufacture of polycrystalline diamond compacts (PDCs) where they are fused and bonded together by a high temperature, high pressure process using a metal catalyst, and supported on a ceramic substrate, can be incorporated onto a drill bit. Such drill bits have been found to provide a superabrasive abrasive surface which is capable of cutting through hard rock for extended periods of time, and under severe down-hole conditions of temperature, pressure, and corrosive down-hole environments, while maintaining the integrity and performance of the drill bit.

While micron diamond particles are very useful in a wide variety of applications, they can be difficult to use together with other smaller particles, such as various nanoparticles, particularly various diamond nanoparticles, due to the significant difference in their sizes. For example, the nanoparticles tend to accumulate in many instances in the interstitial spaces between adjacent micron diamond particles.

Therefore, it is desirable to develop micron diamond nanoparticles that may be incorporated together with other nanoparticles in useful ways, particularly where the nanoparticles may be more uniformly distributed among the micron diamond particles.

### SUMMARY

An exemplary embodiment of a composite particle is disclosed. The composite particle includes a micron diamond particle. The composite particle also includes a nanoparticle, the nanoparticle attached to a surface of the micron diamond particle by an attachment comprising a covalent bond or an intermolecular force, or a combination thereof.

An exemplary embodiment of a method of making a composite particle is also disclosed. The method includes providing a micron diamond particle. The method also includes providing a nanoparticle and attaching the nanoparticle to a surface of the micron diamond particle by an attachment comprising a covalent bond or an intermolecular force, or a combination thereof.

### BRIEF DESCRIPTION OF THE DRAWINGS

Referring now to the drawings wherein like elements are numbered alike in the several Figures:

FIGS. 1A and 1B are schematic sectional illustrations of an exemplary embodiment of a composite particle as disclosed herein, with FIG. 1A illustrating the functionalized nanoparticles and functionalized micron particle prior to formation of the covalent bonds and FIG. 1B illustrating the composite particle and the covalent bonds;

FIGS. 2A and 2B are schematic sectional illustrations of a second exemplary embodiment of a composite particle as disclosed herein, with FIG. 2A illustrating the functionalized nanoparticles and functionalized micron particle prior to formation of the polar bond and FIG. 2B illustrating the composite particle and the polar bonds;

FIGS. 3A and 3B are schematic sectional illustrations of a third exemplary embodiment of a composite particle as disclosed herein, with FIG. 3A illustrating the functionalized nanoparticles and functionalized micron particle prior to formation of the surface tension bonds and FIG. 3B illustrating the composite particle and the surface tension bonds;

FIGS. 4A and 4B are schematic sectional illustrations of a fourth exemplary embodiment of a composite particle as disclosed herein, with FIG. 4A illustrating the functionalized nanoparticles and functionalized micron particle prior to formation of the covalent bonds and FIG. 4B illustrating the composite particle and the covalent bonds; and

FIG. 5 is flow chart of a method of making a composite particle as disclosed herein.

### DETAILED DESCRIPTION

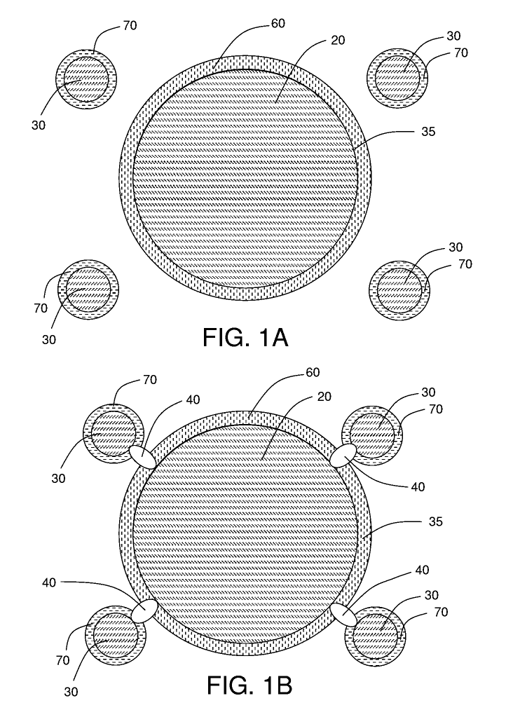

Referring to FIGS. 1-3, a composite particle 10 and method of making the same is disclosed. The composite particle 10 may also be referred to as a particulate composite. The composite particle 10 includes a micron diamond particle 20 as a core material 25 and a nanoparticle 30 that is attached to the surface 35 of the micron diamond particle 20 by a covalent bond 40 or an intermolecular force 50, or a combination thereof. More particularly, nanoparticle 30 may include a plurality of nanoparticles 30 attached at different locations on the surface 35 of the micron diamond particle 20 by a corresponding plurality of covalent bonds 40. Composite particle 10 has at least one nanoparticle 30 disposed on the surface 35 of the micron diamond particle 20, and more particularly may have a plurality of nanoparticles 30 disposed on the surface 35 of micron diamond particle 20. When a plurality of nanoparticles 30 are disposed on micron diamond particle 20, the plurality of nanoparticles 30 may include a predetermined number or average number of nanoparticle 30 disposed on each micron diamond particle 20 as disclosed herein.

Composite particle 10 particles may be used for any suitable purpose, particularly use as a particulate powder, and more particularly for use as a particulate powder in the manufacture of various powder compacts. In one exemplary embodiment, a plurality of composite particle 10 may be used as a powder to form a particulate diamond compact (PDC), such as a PDC used in conjunction with an earth-boring rotary drill bit. In another exemplary embodiment, a plurality of composite particles 10 may be used as a polishing medium. In yet another exemplary embodiment, a plurality of composite particles 10 may be used as an additive in a lubricant, such as a motor pump oil, to provide enhanced thermal conductivity, lubricity or viscosity control. In a further exemplary embodiment, a plurality of composite particles 10 may be used as a strengthening filler material in a polymer or elastomer material.

The micron diamond 20 particles may comprise any suitable type and form of diamond, including natural and synthetic diamonds. A micron diamond particle 20 is a diamond particle having an average particle size of greater than or equal to 1 micrometer (μm). In an embodiment, the average particle size of the micron diamond is about 1 μm to about 250 μm, particularly about 2 μm to about 200 μm, and more particularly about 1 μm to about 150 μm.

The micron diamonds may be monodisperse, where all particles are of substantially the same size with little variation, or polydisperse, where the particles have a range or distribution of sizes and are averaged. Generally, polydisperse micron diamonds are used. Micron diamonds of different average particle size, monodisperse or polydisperse, or both, may be used, and the particle size distribution of the micron diamonds may be unimodal, bimodal, or multi-modal. Micron diamond particles 20, as with the nanoparticles 30, may be used as received, or may be sorted and cleaned by various methods to remove contaminants and non-diamond carbon phases that may be present, such as residues of amorphous carbon or graphite.

In an exemplary embodiment the minimum particle size for the smallest 5 percent of the micron diamonds may be less than about 0.1 μm, particularly less than or equal to about 0.05 μm, and more particularly less than or equal to about 0.01 μm. Similarly, the maximum particle size for 95% of the micron diamond may be greater than or equal to about 1,000 μm, particularly greater than or equal to about 750 μm, and more particularly greater than or equal to about 500 μm.

It will be understood that the average particle sizes of the nanoparticles 30 is less than that of the micron diamond 20. In an exemplary embodiment, the average particle size of the micron diamond is at least about 150 times greater than the average particle size of the nanoparticles 30, particularly about 250 to about 750 times greater than the average particle size of the nanoparticles 30.

Nanoparticle 30 may include any suitable nanoparticle, including various nanoparticle materials, particle shapes and particle sizes. Nanoparticle 30 may include, for example, an inorganic or an organic nanoparticle. An inorganic nanoparticle may include, for example, a metal, ceramic, polysilsesquioxane, clay, carbon or other inorganic nanoparticle, or a combination thereof. An organic nanoparticle may include a polymer nanoparticle.

Carbon nanoparticles may include various graphite, graphene, fullerene or nanodiamond nanoparticles, or a combination thereof. Fullerene carbon nanoparticles may include buckeyballs, buckeyball clusters, buckeypapers, single-wall nanotubes or multi-wall nanotubes, or a combination thereof. Inorganic nanoparticles may include, for example, various metallic carbide, nitride, carbonate or oxide nanoparticles, or a combination thereof. In an exemplary embodiment, suitable metal oxides may include those selected from a group consisting of BeO, ZrO₂, Al₂O₃, SiO₂, and combinations thereof.

As used herein, the term “nanoparticle” means and includes any particle having an average particle size of about 1 μm or less. In one exemplary embodiment, the nanoparticles used herein may have an average particle size of about 0.01 to about 500 nm, and more particularly about 0.1 to about 250 nm, and even more particularly about 1 to about 150 nm. The nanoparticles 30 may be monodisperse, where all particles are of substantially the same size with little variation, or polydisperse, where the nanoparticles 30 have a range or distribution of sizes and are averaged. Generally, polydisperse nanoparticles 30 are used. Nanoparticles 30 of different average particle size, monodisperse or polydisperse, or both, may be used, and the particle size distribution of the micron diamonds may be unimodal, bimodal, or multi-modal.

The nanoparticle 30 used herein may have any suitable shape, including various spherical, symmetrical, irregular, or elongated shapes. They may have a low aspect ratio (i.e., largest dimension to smallest dimension) of less than 10 and approaching 1 in various spherical particles. They may also have a two-dimensional aspect ratio (i.e., diameter to thickness for elongated nanoparticles such as nanotubes or diamondoids; or ratios of length to width, at an assumed thickness or surface area to cross-sectional area for plate-like nanoparticles such as, for example, nanographene or nanoclays) of greater than or equal to 10, specifically greater than or equal to 100, more specifically greater than or equal to 200, and still more specifically greater than or equal to 500. Similarly, the two-dimensional aspect ratio for such nanoparticles may be less than or equal to 10,000, specifically less than or equal to 5,000, and still more specifically less than or equal to 1,000.

Fullerene nanoparticles, as disclosed herein, may include any of the known cage-like hollow allotropic forms of carbon possessing a polyhedral structure. Fullerenes may include, for example, polyhedral buckeyballs of from about 20 to about 100 carbon atoms. For example, C₆₀ is a fullerene having 60 carbon atoms and high symmetry (D₅ₕ), and is a relatively common, commercially available fullerene.

Exemplary fullerenes include, for example, C₃₀, C₃₂, C₃₄, C₃₈, C₄₀, C₄₂, C₄₄, C₄₆, C₄₈, C₅₀, C₅₂, C₆₀, C₇₀, C₇₆, and the like. Fullerene nanoparticles may also include buckeyball clusters. A carbon nanotube is a carbon-based, tubular fullerene structure having open or closed ends and which may be inorganic or made entirely or partially of carbon, and may include also components such as metals or metalloids. Nanotubes, including carbon nanotubes, may be single-wall nanotubes (SWNTs) or multi-wall nanotubes (MWNTs).

A graphite nanoparticle includes a cluster of plate-like sheets of graphite, in which a stacked structure of one or more layers of the graphite, which has a plate-like two dimensional structure of fused hexagonal rings with an extended delocalized π-electron system, layered and weakly bonded to one another through π-π stacking interaction. Graphene nanoparticles, may be a single sheet or several sheets of graphite having nano-scale dimensions, such as an average particle size (average largest dimension) of less than e.g., 500 nanometers (nm), or in other embodiments may have an average largest dimension less than about 1 μm. Nanographene may be prepared by exfoliation of nanographite or by catalytic bond-breaking of a series of carbon-carbon bonds in a carbon nanotube to form a nanographene ribbon by an “unzipping” process, followed by derivatization of the nanographene to prepare, for example, nanographene oxide.

Diamondoids may include carbon cage molecules such as those based on adamantane (C₁₀H₁₆), which is the smallest unit cage structure of the diamond crystal lattice, as well as variants of adamantane (e.g., molecules in which other atoms (e.g., N, O, Si, or S) are substituted for carbon atoms in the molecule) and carbon cage polyadamantane molecules including between 2 and about 20 adamantane cages per molecule (e.g., diamantane, triamantane, tetramantane, pentamantane, hexamantane, heptamantane, and the like).

Polysilsesquioxanes, also referred to as polyorganosilsesquioxanes or polyhedral oligomeric silsesquioxanes (POSS) derivatives are polyorganosilicon oxide compounds of general formula RSiO_{1.5} (where R is an organic group such as methyl) having defined closed or open cage structures (closo or nido structures). Polysilsesquioxanes, including POSS structures, may be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane.

Clays nanoparticles may be hydrated or anhydrous silicate minerals with a layered structure and may include, for example, alumino-silicate clays such as kaolins including hallyosite, smectites including montmorillonite, illite, and the like. Clay nanoparticles may be exfoliated to separate individual sheets, or may be non-exfoliated, and further, may be dehydrated or included as hydrated minerals. Other mineral fillers of similar structure may also be included such as, for example, talc, micas, including muscovite, phlogopite, or phengite, or the like.

Inorganic nanoparticles may also be included in the composition. Any suitable inorganic nanoparticle material may be used. An exemplary inorganic nanoparticle may include a metal or metalloid (metallic) boride such as titanium boride, tungsten boride and the like; a metal or metalloid carbide such as tungsten carbide, silicon carbide, boron carbide, or the like; a metal or metalloid nitride such as titanium nitride, boron nitride, silicon nitride, or the like; a metal or metalloid oxide such as aluminum oxide, silicon oxide or the like; a metal carbonate, a metal bicarbonate, or a metal nanoparticle, such as iron, cobalt or nickel, or an alloy thereof, or the like.

Referring to FIGS. 1A and 1B, the covalent bond 40 may be any suitable covalent bond between nanoparticle 30 and micron diamond particle 20. The type of covalent bond 40 selected may be selected based on the intended use of composite particle 10. If, for example, composite particle 10 is to be used to form a powder compact, such as by high temperature, high pressure sintering, covalent bond 40 may be selected so that the processes used to form the powder compact may be used to convert some or all of the constituent atoms of covalent bond 40 into reaction products that are removed during the process of forming the powder compact, or into reaction products which are incorporated into the powder compact. In the case where a plurality of covalent bonds 40 are used to attach a corresponding plurality of nanoparticles 30 to surface 35 of micron diamond particle 20, the plurality of covalent bonds 40 may the same type of covalent bond 40, or may comprise different types of covalent bonds 40. In an exemplary embodiment, the bond may include a peptide or amide bond (—CONH—) bond. This is a covalent chemical bond formed between two molecules when the carboxyl group of one molecule reacts with the amine group of the other molecule, thereby releasing a molecule of water (H₂O). This is a dehydration synthesis reaction (also known as a condensation reaction), and usually occurs between amino acids. The resulting C(O)NH bond is called a peptide bond, and the resulting molecule is an amide. The four-atom functional group —C(═O)NH— is called a peptide link, and may be used, for example, by reaction of an amine functionalized nanoparticle 30 to a carboxyl functionalized micron diamond particle 20, or vice versa, where the micron diamond particle is 20 is amine functionalized and the nanoparticle 30 is carboxyl functionalized. Many other types of covalent bonds 40 may be employed. In an exemplary embodiment, the covalent bond 40 comprises a covalent bond that is not a crosslink bond between a first polymer disposed on the micron diamond particle 20 and a second polymer disposed on the nanoparticle 30, where the first polymer and the second polymer are the same polymer, or, stated differently, covalent bond 40 comprises a covalent bond that is other than a covalent bond formed as a crosslink bond during a polymerization reaction comprising crosslinking of a single polymer material. In another exemplary embodiment, the covalent bond 40 comprises a covalent bond that is a crosslink bond between a first polymer disposed on the micron diamond particle 20 and a second polymer disposed on the nanoparticle 30, where the first polymer and the second polymer are different polymer materials, or, stated differently, covalent bond 40 comprises a covalent bond that is formed as a crosslink bond during a polymerization reaction comprising crosslinking of two different polymer materials. In yet another embodiment, the covalent bond 40 comprises a covalent bond that is formed by reaction of a first functional group 60 disposed on a functionalized micron diamond particle 20 and a second functional group 70 disposed on a functionalized nanoparticle 30, where the first functional group and the second functional group are different functional groups and covalent bond 40 comprises a reaction product of the first functional group 60 and the second functional group 70. The first functional group 60 and second functional group 70 may be selected based on the desired use or application of the composite particle 10. For example, if composite particle 10 is to be used directly in an application (e.g., a polishing or other surface finishing medium or fluid additive), the covalent bond 40 created must be sufficient to maintain the bonded relationship of nanoparticle 30 and micron diamond particle 20 throughout the course of the application. In contrast, if composite particle 10 is a precursor to be used to produce a different composition of matter or article of manufacture, such as, for example, a powder compact formed of composite particles 10, covalent bond 40 need only be sufficient to maintain the bonded relationship of nanoparticle 30 and micron diamond particle 20 until the precursor material is converted by chemical reaction or otherwise (e.g., sintering) into the desired composition of matter or article of manufacture. Further, the material of covalent bond 40 may be selected to promote the physical or chemical processes used to form the desired composition of matter or article of manufacture, such as chemical bonding. Alternately, the material of covalent bond 40 may be selected to promote its removal in conjunction with the physical or chemical processes used to form the desired composition of matter or article of manufacture. It will also be understood that combinations of use and removal of the constituents of the material of covalent bond 40 in the physical or chemical processes used to form the desired composition of matter or article of manufacture from composite particles 10 may be employed.

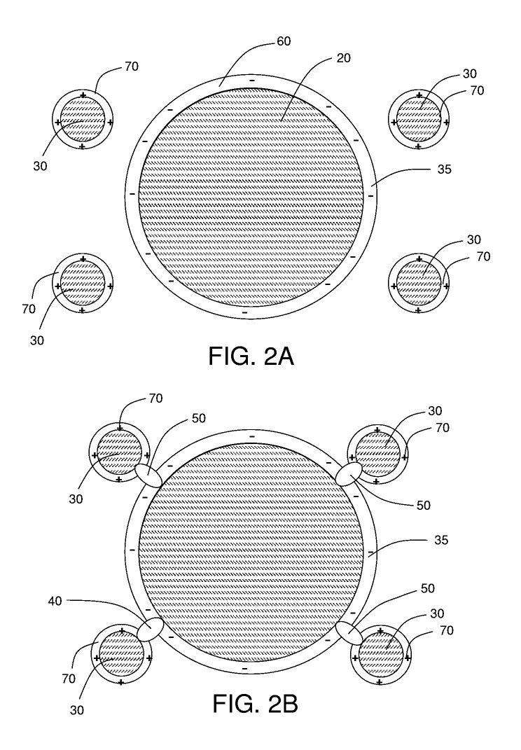

Referring to FIGS. 2A and 2B, an intermolecular force 50 between micron diamond particle 20 and nanoparticle 30 may include, for example, van der Waals forces, dispersion forces, polar forces or forces resulting from hydrogen bonding. An intermolecular force 50 may be established in any suitable manner between micron diamond particle 20 and nanoparticle 30, or a plurality of nanoparticles 30. In one exemplary embodiment, micron diamond particle 20 may be derivatized or functionalized, such as by disposing a first functional group 60 on the surface 35 of micron diamond particle 20, and nanoparticle 30 may be derivatized or functionalized, such as by disposing a second functional group 70 on the surface 75 of nanoparticle 30. The first functional group 60 and the second functional group 70 may be selected to establish a desired intermolecular force. For example, micron diamond particle 20 may be functionalized to include a strongly electronegative functional group, such as a strongly electronegative ion or molecule (e.g., F⁻¹, Cl⁻¹, Br⁻¹ or I⁻¹ or a combination thereof and the like) and nanoparticle 30 may be functionalized to include a strongly electropositive functional group, such as a strongly electropositive ion or molecule (e.g., a metallic ion or molecule such as Ag⁺¹, Co⁺², Fe⁺² and Ni⁺² or a combination thereof and the like). The first functional group 60 of micron diamond particle 20 and second functional group 70 of nanoparticle 30 may be selected to produce the desired type and magnitude of intermolecular force 50. The first functional group 60 and second functional group 70 may be selected based on the desired use or application of the composite particle 10. For example, if composite particle 10 is to be used directly in an application (e.g., a polishing or other surface finishing medium or fluid additive), the intermolecular force 50 created must be sufficient to maintain the bonded relationship of nanoparticle 30 and micron diamond particle 20 throughout the course of the application. In contrast, if composite particle 10 is a precursor to be used to produce a different composition of matter or article of manufacture, such as, for example, a powder compact formed of composite particles 10, intermolecular force 50 need only be sufficient to maintain the bonded relationship of nanoparticle 30 and micron diamond particle 20 until the precursor material is converted by chemical reaction or otherwise (e.g., sintering) into the desired composition of matter or article of manufacture.

The first functional group 60 of micron diamond particle 20 may be any material suitable to functionalize the surface 35 of the diamond, including a variety of organic or inorganic materials. First functional group 60 may include an organic functional group, such as, for example, a carboxy, epoxy, ether, ketone, amine, hydroxyl, alkoxy, alkyl, lactone, aryl functional group, and combinations thereof, and including a polymeric or oligomeric group functionalized therewith. First functional group 60 may also include electronegative or electropositive ions or molecules, including those of various inorganic materials as described herein.

The second functional group 70 of nanoparticle 30 may be any material suitable to functionalize the surface 75 of the material comprising nanoparticle 30, including a variety of organic or inorganic materials. Second functional group 70 may include an organic functional group, such as, for example, a carboxy, epoxy, ether, ketone, amine, hydroxyl, alkoxy, alkyl, lactone, aryl functional group, and combinations thereof, and including a polymeric or oligomeric group functionalized therewith. Second functional group 70 may also include electronegative or electropositive ions or molecules, including those of various inorganic materials as described herein. In an exemplary embodiment, first functional group 60 is different than second functional group 70. In another exemplary embodiment, first functional group 60 may be the same as second functional group 70, provided that the attachment of nanoparticle 30 to micron diamond particle 20 does not comprise a covalent bond 40 formed by crosslinking the same polymeric material.

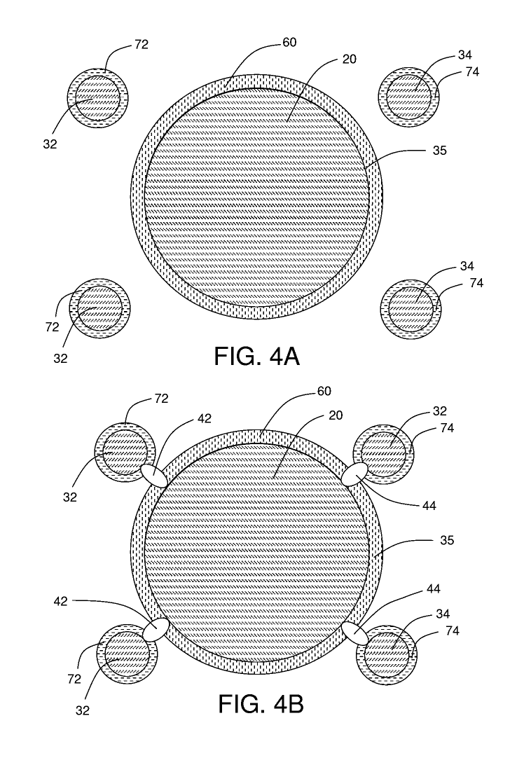

Referring to FIGS. 4A and 4B, wherein a plurality of nanoparticles 30 are attached to the surface 35 of micron diamond particle 20, the nanoparticles 30 may include the same nanoparticle material or different nanoparticle materials, for example, a plurality of first nanoparticles 32 may be attached to the surface of micron diamond particle 20 together with a plurality of second nanoparticles 34. The first nanoparticles 32 and second nanoparticles 34 may be made from the same or different materials, and may also have the same shape or different shapes, as well as the same particle size or different particle sizes. First nanoparticles 32 may be functionalized with a first type 72 of second functional groups 70 configured to form a plurality of first covalent bonds 42. Second nanoparticles 34 may be functionalized with a second type 74 of second functional groups 70 configured to form a plurality of second covalent bonds 44, or alternately a plurality of second intermolecular forces 54. The first type 72 and second type 74 of second functional groups 70 may be the same or different and may be used to produce, for example, the same types of covalent bonds or different types of covalent bonds. In an exemplary embodiment, first nanoparticles 32 may be nanodiamonds and second nanoparticles may be metal nanoparticles, such as Co nanoparticles.

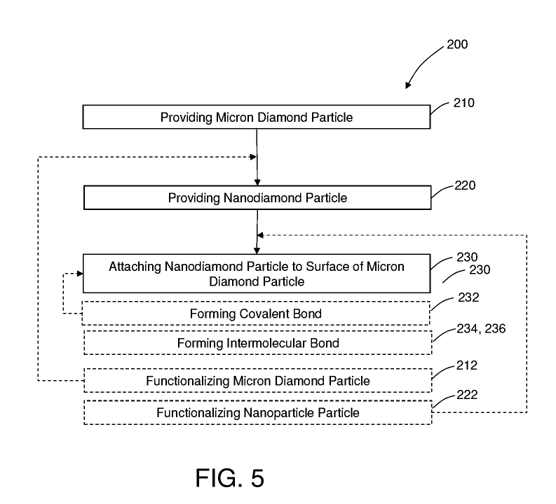

Referring to FIG. 5, a method 200 of making a composite particle 10, includes providing 210 a micron diamond particle 20. Method 200 also includes providing 220 a nanoparticle 30. Method 200 further includes attaching 230 the nanoparticle 30 to a surface 35 of the micron diamond particle 20 by an attachment comprising a covalent bond 40 or an intermolecular force 50, or a combination thereof.

In an exemplary embodiment, method 200 includes providing 210 a functionalized micron diamond particle 20 as described herein by functionalizing 212 the surface 35 of the micron diamond 20 with a first functional group 60. In this embodiment, method 200 includes providing 220 a functionalized nanoparticle 30 as described herein by functionalizing 222 a surface 75 of the nanoparticle 30 with a second functional group 70. In this embodiment, attaching 230 includes forming 232 a covalent chemical bond 40 between the nanoparticle 30 and the micron diamond particle 20 by a chemical reaction involving the first functional group 60 and the second functional group 70.

In another exemplary embodiment, method 200 includes providing 210 a functionalized micron diamond particle 20 as described herein by functionalizing 212 the surface 35 of the micron diamond 20 with a first functional group 60. In this embodiment, method 200 includes providing 220 a functionalized nanoparticle 30 as described herein by functionalizing 222 a surface 75 of the nanoparticle 30 with a second functional group 70. In this embodiment, attaching 230 includes forming 234 an intermolecular force 50 between the nanoparticle 30 and the micron diamond particle 20 comprising a polar force or polar bond between the first functional group 60 and the second functional group 70. In this embodiment, first functional group 60 may include one of an electropositive or electronegative functional group, and second functional group 70 may also include one of an electropositive or electronegative functional group having a charge that is opposite to that of the first functional group 60.

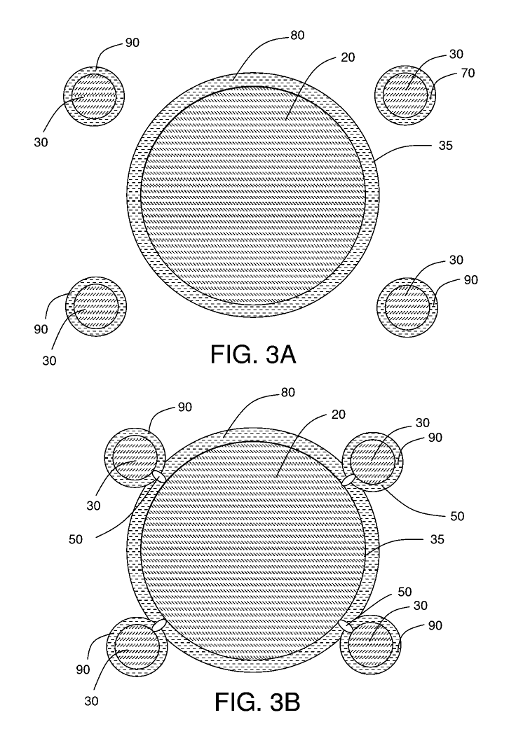

Referring also to FIGS. 3A and 3B, in yet another exemplary embodiment, method 200 includes providing 210 a micron diamond particle 20 as described herein by coating the surface of the micron diamond with a first fluid 80 having a first surface tension 85. In this embodiment, method 200 includes providing 220 a nanoparticle 30 as described herein by coating 226 the surface of the nanoparticle with a second fluid 90 having a second surface tension. In this embodiment, attaching 230 includes forming 236 an intermolecular force 50 between the nanoparticle 30 and the micron diamond particle 20, such as a surface tension force between the first fluid 80 and micron diamond particle 20 and the second fluid 90 and nanoparticle 30. First fluid 80 and second fluid 90 may be the same fluid, such that the surface tension force is attributable to the differential sizes and/or materials of micron diamond particle 20 and nanoparticle 30 and their associated wetting angles. First fluid 80 and second fluid 90 may also be different fluids, such that the surface tension force is attributable to the differential sizes and/or materials of micron diamond particle 20 and nanoparticle 30 and the associated wetting angles of first fluid 80 and second fluid 90 on these particles 70. In an exemplary embodiment, the surface tension force may be about 15 to about 80 dynes/cm.

While one or more embodiments have been shown and described, modifications and substitutions may be made thereto without departing from the spirit and scope of the invention. Accordingly, it is to be understood that the present invention has been described by way of illustrations and not limitation.

1. A composite particle, comprising:
a micron diamond particle; and
a nanoparticle, the nanoparticle attached to a surface of the micron diamond particle by an attachment comprising a covalent bond or an intermolecular force, or a combination thereof.

2. The composite particle of claim 1, wherein the nanoparticle comprises an inorganic material or an organic material.

3. The composite particle of claim 2, wherein the inorganic material comprises a metal, ceramic, polysilsesquioxane, clay or carbon, or a combination thereof.

4. The composite particle of claim 3, wherein the inorganic material comprises a ceramic, the ceramic comprising a metal oxide, metal nitride or metal carbide, or a combination thereof.

5. The composite particle of claim 4, wherein the ceramic comprises a metal oxide selected from a group consisting of BeO, ZrO₂, Al₂O₃, SiO₂, and combinations thereof.

6. The composite particle of claim 1, wherein the nanoparticle comprises a carbon nanoparticle.

7. The composite particle of claim 1, wherein the carbon nanoparticle comprises a nanographene, nanographite, fullerene, single-wall nanotube, multi-wall nanotube or nanodiamond particle, or a combination thereof.

8. The composite particle of claim 1, wherein the nanoparticle comprises a plurality of nanoparticles.

9. The composite particle of claim 8, wherein the plurality of nanoparticles comprise nanodiamond particles.

10. The composite particle of claim 8, wherein plurality of nanoparticles comprises a plurality of first nanoparticles and a plurality of second nanoparticles.

11. The composite particle of claim 8, wherein each of the plurality of nanoparticles is attached to the surface of the micron diamond particle by one of a covalent bond or an intermolecular force, or a combination thereof.

12. The composite particle of claim 10, wherein the plurality of first nanoparticles is attached to the surface of the micron diamond particle by a corresponding plurality of first covalent bonds and the plurality of second nanoparticles is attached to the surface of the micron diamond particle by a corresponding plurality of second covalent bonds.

13. The composite particle of claim 12, wherein the plurality of first covalent bonds are different than the plurality of second covalent bonds.

14. The composite particle of claim 1, wherein the micron diamond particle comprises a functionalized micron diamond particle having a first functional group disposed thereon and the nanoparticle comprises a functionalized nanoparticle having a second functional group disposed thereon, and the attachment comprises an polar force between the first functional group and the second functional group.

15. The composite particle of claim 1, wherein the attachment comprises an intermolecular force comprising a surface tension force of a first fluid disposed on the surface of the micron diamond and a second fluid disposed on a surface of the nanoparticle.

16. A method of making a composite particle, comprising:
providing a micron diamond particle;
providing a nanoparticle; and
attaching the nanoparticle to a surface of the micron diamond particle by an attachment comprising a covalent bond or an intermolecular force, or a combination thereof.

17. The method of claim 16, wherein attaching comprises:
functionalizing the surface of the micron diamond with a first functional group;
functionalizing a surface of the nanoparticle with a second functional group; and
forming a covalent chemical bond between the nanoparticle and the micron diamond particle by a chemical reaction involving the first functional group and the second functional group.

18. The method of claim 17, wherein the nanoparticle comprises an inorganic material or an organic material and the first functional group comprises carboxy, epoxy, ether, ketone, amine, hydroxyl, alkoxy, alkyl, lactones, aryl, functionalized polymeric or oligomeric groups, or a combination thereof.

19. The method of claim 18, wherein the second functional group comprises carboxy, epoxy, ether, ketone, amine, hydroxyl, alkoxy, alkyl, lactones, aryl, functionalized polymeric or oligomeric groups, or a combination thereof.

20. The method of claim 16, wherein attaching comprises:
coating the surface of the micron diamond with a first fluid;
coating the surface of the nanoparticle with a second fluid; and
forming an intermolecular force between the first fluid and the nanoparticle and the second fluid and the micron particle.

21. The method of claim 20, wherein the intermolecular force comprises a surface tension force between the first fluid and the second fluid.

22. The method of claim 21, wherein the surface tension force is about 15 to about 80 dynes/cm.

23. The method of claim 16, wherein the composite particle of claim 1, wherein the carbon nanoparticle comprises a nanographene, nanographite, fullerene, single-wall nanotube, multi-wall nanotube or nanodiamond particle, or a combination thereof.

24. The method of claim 16, wherein the nanoparticle comprises a plurality of nanoparticles.

25. The method of claim 16, wherein each of the plurality of nanoparticles is attached by a respective attachment to the surface of the micron diamond particle by one of a covalent bond or an intermolecular force, or a combination thereof.
